(19) United States
(12) Patent Application Publication
(10) Pub. No.: US 2023/0417514 A1
(43) Pub. Date: Dec. 28, 2023

(54) HANDHELD, NON-LETHAL DETERRENT SPRAYING DEVICE AND HOLSTER

(71) Applicant: Zachary Owen Rebro, Lynden, WA (US)

(72) Inventor: Zachary Owen Rebro, Lynden, WA (US)

(21) Appl. No.: 17/850,742

(22) Filed: Jun. 27, 2022

(51) Int. Cl. F41H 9/10; F41C 33/02

(52) U.S. Cl. CPC F41H 9/10; F41C 33/0263; F41C 23/10

(57) ABSTRACT

A handheld, non-lethal deterrent spraying device comprising a housing structure configured to have a grip portion and a top portion, the grip portion and top portion being aligned to give the housing structure a pistol-grip orientation; a reservoir within the grip portion of the housing structure for containing a non-lethal deterrent; a nozzle recessed in a notch on the distal end of the top portion of the housing structure; a channel that connects the reservoir to the nozzle; an actuator that is accessible by a user and is manipulated by the user to engage a depressing member that causes the reservoir to discharge the reservoir's contents through the channel and out the nozzle; a cover member over the actuator, said cover member being attached to the housing structure, and being pivotable between a locked position which covers the actuator and an active position; and a specialized holster designed to hold the device and include a lockable hood to prevent undesired retrieval of the device.

### FIELD OF THE INVENTION

The present invention relates to an improved handheld, non-lethal deterrent spraying device and a specialized holster for that device.

### BACKGROUND OF THE INVENTION

In recent years, trends for law enforcement agencies have favored non-lethal means to incapacitate a subject. Additionally, private citizens have also found a growing need for personal protection devices that are easy to use and non-lethal. Thus, a growing demand exists for non-lethal technological alternatives that are used to incapacitate and/or impede the motion of aggressive, violent, combative, non-compliant, or high-risk subjects or attackers who pose a risk to law enforcement, military, corrections, private security, licensed citizens, the general public, and property.

There are various commercially available self-defense devices for this purpose, including audible alarms, batons, bean bag firearms, pepper-ball projectiles, pepper sprays, multifunctional devices, conducted electrical weapons, and stun guns. Conventional pepper sprays, also known as OC spray or OC gas are lachrymatory agents, use chemical compounds (sometimes contained within pressurized canisters) to irritate a subject or attacker's eyes, sinuses, and nose, causing tears, pain, and temporary blindness. Temporary blindness is particularly useful for law enforcement as it allows them to restrain an assailant more easily. When used by civilians in self-defense scenarios, temporarily blinding an attacker can provide the user the opportunity to flee a potentially life-threatening situation. Furthermore, chemical sprays are typically ranged devices, giving the user the ability to deter the attacker from as far away as 10 to 20 feet. Conventional pepper sprays are commercially available in a variety of sizes, often in compact pressurized canisters that can be concealed and/or used in multifunctional devices (i.e., flashlights, batons, portable audio devices, keychains, ornamental jewelry, etc.). Compact pressurized canisters allow the user to discretely carry the device in a purse or bag.

One issue with many of the available personal protection devices, such as OC, PAVA, or PAVA2 sprays, is that these devices may be difficult to use even for individuals who have received training for a specific device. This difficulty is compounded by the pressure, distress, and/or panic of any situation wherein using such a handheld, non-lethal deterrent spraying device would be necessary. Many versions of non-lethal deterrent sprays are essentially a pressurized, tubular cannister with a spray actuator on the top. These devices are sometimes incorrectly used by civilians who are panicked, in a poorly lit area, and have not previously ejected the contents of such a device. This may even result in the user spraying the contents of the device into the user's face instead of an approaching attacker's face. Therefore, there is a need for a handheld, non-lethal deterrent spraying device with an easy-to-use structure that is has a familiar shape and configuration. This familiarity will help reduce the risk of misfiring the device and increase the user's accuracy while discharging the non-lethal deterrent spray. One example of a familiar and easy-to-use shape is a handheld, non-lethal deterrent spraying device with a slanted or “pistol” grip.

Further, even with a device with a pistol grip, some users may have difficulty seeing an approaching attacker due to the potentially life-threatening situation taking place in a poorly lit area. Therefore, an illumination device (such as a single or an array of LEDs or a laser diode) facing the same direction as the nozzle of the non-lethal deterrent spray may be desirable. There are additional benefits of having a multiple purpose device including a flashlight and a non-lethal deterrent spray; however, the primary benefit would be to identify the attacker and to more accurately dispense the contents of the non-lethal deterrent spray into the attacker's face.

Further, even if the user is in a well-lit area, the user may have difficulty attempting to accurately spray the contents of the handheld, non-lethal deterrent spraying device at the attacker's face. Therefore, there is a need for a handheld, non-lethal deterrent spraying device with features such as a flashlight to illuminate the target and further features such as a laser “sight” that enhances the user's accuracy.

A specialized holster provides many benefits to users of the handheld, non-lethal deterrent spraying device. The holster may allow the user to store their device on the user's person, in a position where the device may be quickly retrieved. Some holsters may provide added benefits such as a locking mechanism that prevents accidental or undesired retrieval of the device from the holster. This benefit is particularly helpful to law enforcement officials. These specialized holsters are most effective when they are designed for a specific device.

Considering the foregoing, there is a need in the market for an intuitive-to-use handheld, non-lethal deterrent spraying device comprised of a non-lethal deterrent spray, a light to illuminate the area, a mechanism to aid the user's aim, and a specialized holster designed to provide desirable quick retrieval and secured storage of device.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to a handheld, non-lethal deterrent spraying device comprising a housing structure configured to have a grip portion and a top portion, the grip portion and top portion being aligned to give the housing structure a pistol-grip orientation, the grip portion and top portion having interiors and exteriors, and the top portion having a distal end opposite the end of the top portion coupled to the grip portion; a reservoir within the grip portion of the housing structure for containing a non-lethal deterrent; a nozzle recessed in a notch on the distal end of the top portion of the housing structure; a channel that connects the reservoir to the nozzle; an actuator that is accessible by a user and is manipulated by the user to engage a depressing member that causes the reservoir to discharge the reservoir's contents through the channel and out the nozzle; and a cover member over the actuator, said cover member being attached to the housing structure, and being pivotable between a locked position which covers the actuator and an active position which allows a user to engage the actuator.

The subject matter disclosed and claimed herein, in further embodiments of the present invention, relates to the handheld, non-lethal deterrent spraying device including a holster having a holding chamber having an interior and an exterior, and configured to receive the distal end of the top portion of the handheld, non-lethal deterrent spraying device into the interior; a hood hingedly attached to the holding chamber, the hood having an interior and exterior, and being pivotable between a closed position and an open position about the handheld, non-lethal deterrent spraying device; and a means for securing the holster that is attached to the holding chamber.

The subject matter disclosed and claimed herein, in further embodiments of the present invention, relates to a unit of swappable pieces for a handheld, non-lethal deterrent spraying device comprising a reservoir designed to reside within a grip portion of a housing structure of the handheld, non-lethal deterrent spraying device, the reservoir containing a non-lethal deterrent; a nozzle recessed in a notch on the distal end of a top portion of the housing structure; a channel that connects the reservoir to the nozzle; and a depressing member that causes the reservoir to discharge the reservoir's contents through the channel and out the nozzle when the depressing member is engaged by an actuator on the handheld, non-lethal deterrent spraying device that is manipulated by a user.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is a side view of one embodiment the present invention.

FIG. 2 is an isometric view of the front of one embodiment the present invention in a locked position.

FIG. 3 is an isometric view of the back of one embodiment the present invention in an active position.

FIG. 4 is a cross section of one embodiment the present invention.

FIG. 5 is an isometric of one embodiment of a holster in an open position that is part of the present invention.

FIG. 6 is an isometric view of one embodiment of a holster in a closed position that is part of the present invention.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As previously mentioned, there exists a need in the market for an easy-to-use handheld, non-lethal deterrent spraying device that includes an intuitive-to-use design and having a plurality of features. This plurality of features includes elements such as a locking mechanism over the actuator or trigger to prevent undesired discharge of the non-lethal deterrent spray, a light built into the device to illuminate what a user is pointing at, and a laser to help guide the user's aim. Further, users will appreciate a specialized holster designed to secure the device as well as provide reliable, quick access for deployment of the device. Finally, replaceable units of reservoir containers provide an economic advantage to a user that purchases a housing structure having the plurality of features.

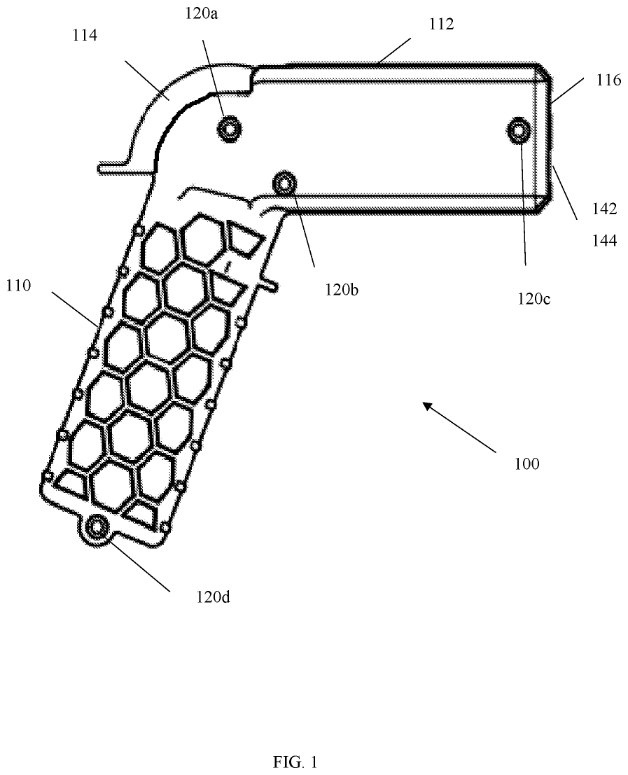

FIG. 1 provides a side view of one embodiment of the present invention. In some embodiments, the present invention is a handheld, non-lethal deterrent spraying device 100 (or sometimes simply the “device” or “present invention”) having a housing structure comprised of a grip portion 110 and a top portion 112 that are aligned in a pistol-grip orientation. In ideal embodiments, the housing structure is made of a durable, cost-effective material such as hardened plastics, metal, rubber, wood, materials with similar attributes to the foregoing, and combinations thereof. The housing structure has an exterior and an interior. In some embodiments, the housing structure is held together by a plurality of fasteners 120 (shown as 120a, 120b, 120c, 120d).

In some embodiments the grip portion 110 and the top portion 112 are created as a single piece, having two halves that are couple by the plurality of fasteners 120. In alternative embodiments, the grip portion 110 and the top portion 112 may be separate pieces, possibly made of different materials, which are coupled to form the housing structure of the handheld, non-lethal deterrent spraying device 100.

In some embodiments, the grip portion 110 may be configured to provide the user with a firm, non-slipping grasp on the device. This desired effect may be achieved by the materials used to manufacture the grip portion 110, the design of the grip portion 110, additional items being added to the grip portion such as rubber pieces, a cover, or a non-slip coating or treatment, or any combination of the foregoing.

In some embodiments, an actuator is built into the handheld, non-lethal deterrent spraying device 100 and is covered by a hingedly attached cover member 114. The cover member 114 provides a level of prevention of accidental discharge of the non-lethal deterrent spray by covering the actuator. The cover member 114 is in a locked position when it covers the actuator. In some embodiments, the cover member 114 has a lip that allows a user to easily bias the cover member out of the locked position, revealing the actuator in what is called an active position. The biasing or upwards rotation of the cover member 114 is relative to the hinge along the top of the handheld, non-lethal deterrent spraying device 100. In some embodiments, the user may intuitively and quickly flick the cover member 114 upwards and then immediately push his or her thumb downwards onto the actuator to spray the contents of a reservoir of a non-lethal deterrent spray within the housing structure. This method of deployment is ideal as the user could either prepare to spray by flipping the cover member 114 up and immediately activate the device or allowing the user to warn a target of the user's intent to discharge the contents of the device.

In some embodiments, the distal end of the top portion 112 is configured to have a notch to receive a nozzle 116 and adapted to house at least two light emitting devices, such as a laser diode 142 and an LED light 144 to serve as a flashlight or light source.

In some embodiments, the pistol-grip orientation for the grip portion 110 and the top portion 112 is selected because it provides the user with a familiar grip and aiming method. The pistol-grip orientation best mimics a handgun which intuitively allows the user (particularly those with law enforcement training) to aim down the top portion 112 at a target. In further embodiments, the top portion 112 may further include sights which aid the user's aim at the target.

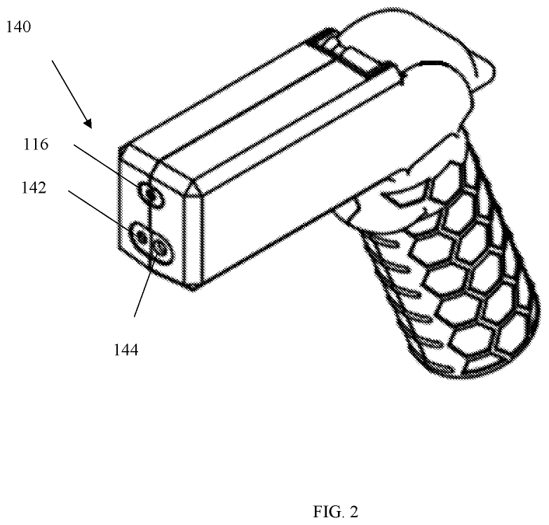

FIG. 2 is an isometric view of the front of one embodiment the present invention in the locked position. In some embodiments, the handheld, non-lethal deterrent spraying device 100 may have a plurality of functioning members 140 on the distal end of the top portion of the housing structure. This plurality of functioning members 140 may include, but is not limited to, the nozzle 116 for dispensing the non-lethal deterrent spray, the laser diode 142, and the LED light 144. The nozzle 116 may be adjustable to manipulate the distance, spread, angle, or other properties of the spray as it exits the device. The laser diode 142 may be used as a laser sight to aid the user in hitting the user's desired target. The laser diode 142 may project a beam that displays a dot on a surface, it may project a target circle, it may project a distance gauging image, or other desirable projections that aid the user's aim. The LED light 144 may emit light of a desirable intensity (usually measured in lumens), distance, spread, angle, and duration. In some embodiments, the LED light 144 may be configured to obfuscate the user from the user's target (for example, due to intensity or angle or both).

In some embodiments, the plurality of functioning members 140 may include other light emitting members such as a group of light emitting diodes, incandescent bulbs, fluorescent bulbs, compact florescent bulbs, pressurized bulbs, high-intensity discharge bulbs, and combinations thereof.

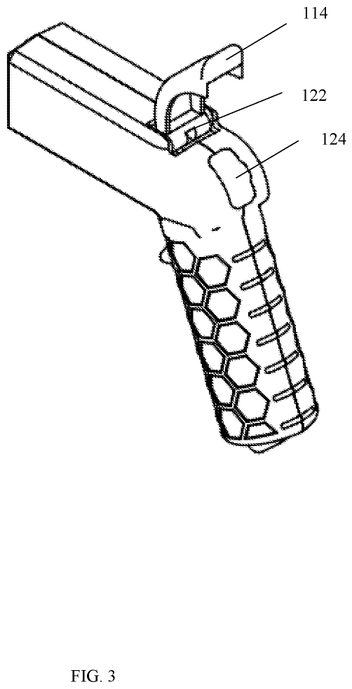

FIG. 3 is an isometric view of the back of one embodiment the present invention in an active position. In some embodiments, the handheld, non-lethal deterrent spraying device 100 may be flipped to the active position by rotating the cover member 114 upwards about a hinge or axis. This may be accomplished by a simple hinge 122 that may include a retention member such as a spring. Further, the hinge 122 may have a soft-locking mechanism when the device is in the locked position and/or the active position that prevents the cover member 114 from undesirably moving. In some embodiments, the soft-locking mechanism should be designed such that minimal manipulation by a user disengaged the lock so that the user may easily close and open the cover member 114.

In some embodiments, beneath the cover member 114 lies an actuator 124 that, when manipulated by the user, activates the device. Some examples of actuators that may be used in the present invention include a push button, a toggle switch, a selector switch, a proximity switch, a pressure switch, a bidirectional switch, etc. In some embodiments, the actuator is a bidirectional switch (such as one that goes forwards and backwards). This bidirectional switch may activate the plurality of functioning members when pressed in one direction and discharge the contents of a reservoir when pressed in the other direction. For example, pushing the actuator upwards may activate a laser diode and LED bulb, and pushing the actuator downwards may cause the present invention to discharge the non-lethal deterrent spray from the reservoir. Regardless of the type of actuator selected by the manufacturer of the device, all suitable actuators should desirably activate the device when manipulated by the user.

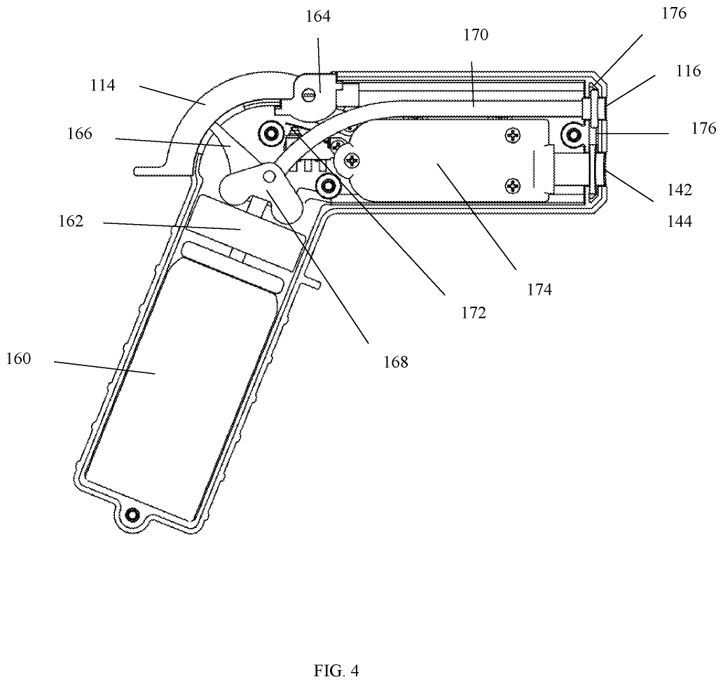

FIG. 4 is a cross section of one embodiment the present invention. The interior of the housing structure contains, in some embodiments, a reservoir 160 that may be manipulated by a depressing member 162 and having a channel 170 that connects the reservoir 160 to the nozzle 116 which lies, recessed, within a notch 176 or similar receiver for the nozzle 116. In some embodiments, the reservoir 160 contains a non-lethal deterrent spray in aerosolized, gaseous, or liquid form. Some common non-lethal deterrent sprays that are currently used or were used in the past include, but are not limited to, oleoresin capsicum, pelargonic acid vanillylamide, diluted chloroacetophenone (commonly known as “mace” or “CN”), and red pepper gel. The reservoir 160 may also be filled an inert training spray that does not have any deterrent in it. The channel 170 may include an activation mechanism 168 such as a flange or pressure release system that maintains pressure on the contents of the reservoir 160. In some embodiments, the activation mechanism 168 applies pressure to the depressing member 162, which depresses onto a reservoir nozzle located on the reservoir 160 releasing its contents. In some embodiments, when a switch 166 is manipulated by the user (the switch 166 being one embodiment of the actuator 124) the contents of the reservoir 160 are released, travel through the channel 170, and exit the nozzle 116. In some embodiments, the reservoir 160 may contain an aerosolized oleoresin capsicum spray or other suitable deterrent.

The depressing member 162 may help retain the reservoir 160 within the grip portion of the housing structure. Further, the depressing member 162 may prevent the contents of the reservoir 160 from undesirably traveling about the rest of the housing structure if there were to be an undesirable event (such as the reservoir 160 leaking). Lastly, the depressing member 162 may cause the discharge of the contents of the reservoir 160 when the depressing member 162 is manipulated by the user through the actuator and/or associated mechanics (such as a flange). It is possible, in some embodiments, that the channel 170 is two pieces that are connected to, first, the reservoir 160 and the depressing member 162, and second, the depressing member 162 and the nozzle 114. In some embodiments, the channel 170 should include a receptacle that is adapted to couple with the reservoir 160 that facilitates the movement of the contents of the reservoir 160 into the channel 170.

In some embodiments, the reservoir 160 is replaceable. In further embodiments, the reservoir 160 may be accessed via a slotted door or removable piece, or by disassembling the grip portion or a larger portion of the housing structure. In even further embodiments, such as the depicted embodiment, the reservoir 160 may be part of a unit of swappable pieces including the depressing member 162, the channel 170, and the nozzle 116. The activation mechanism 168 may be removeable or the channel 170 and the nozzle 116 may slide through the activation mechanism 168 when removing the unit of swappable pieces. This embodiment may be ideal for some because replacing this unit of swappable pieces instead of just the reservoir 160 ensures that there is no residue left in the channel 170 or nozzle 116 that may affect the device's use. Further, the unit of swappable pieces may include a removeable safety spacer that prevents the depressing member 162 or other force exerting onto the reservoir 160 which could cause an accidental discharge of the contents of the reservoir 160. In some embodiments, this removeable safety spacer could be in the form of a safety tab (which may be made of rubber, plastic, or another suitable material) that is easily removed after the unit of swappable pieces is secured within the housing structure.

In some embodiments, the housing structure may contain a compartment 174 that holds the necessary components to activate the plurality of functioning members 140 such as the LED light 144 and laser diode 142. These components may include a power supply, the plurality of functioning members, and required circuitry to facilitate the operation of those functioning members. Some embodiments may further include a small computer system having at least one processor, at least one memory storage, at least one RAM chip, circuitry, and at least one set of instructions stored on the at least one memory storage. The power supply includes a battery which provides power to the light emitting members and a means for charging the battery. In some embodiments, the means for charging the battery include a port that couples to a cable which supplies power from another battery or source such as a wall outlet, or an internal inductive charging unit which is supplied a flow of power from an external inductive charger that receives its power from another battery or wall outlet. When activated by the user, at least one of the plurality of functioning members will perform its function, such as the laser diode projecting light which provides a target guide to aid the user's aim.

In some embodiments, a cover retaining member 164 may be attached to the top portion of the housing structure and may activate a functioning member switch 172 when the cover 114 is moved from the locked position to the active position. When the cover is in the active position, the depression of the cover retaining member 164 on the functioning member switch 172 activates, in some embodiments, the LED light 144 and laser diode 142.

In some embodiments, it is desired that the notch 176 that receives the nozzle 116 provides adequate snugness as to align the nozzle 116 for accurate dispensing of the contents of the reservoir 160. In fact, retaining the devices accuracy when replacing the unit of swappable pieces is a key benefit of the present invention. This desirable feature of securing the nozzle 116 within the recess of the notch 176 may be accomplished by any, or a combination of, adequate configuration including using a securing clip, pin, screw, or the like, configuring the nozzle 116 to fit very snuggly within the recessed area of the notch 176, binding the nozzle 116 within the recessed area of the notch 176 by a temporary and/or weak adhesive, securing the nozzle 116 within the notch 176 when reassembling the two pieces of the top portion of the housing structure when replacing the unit the swappable pieces, and so on.

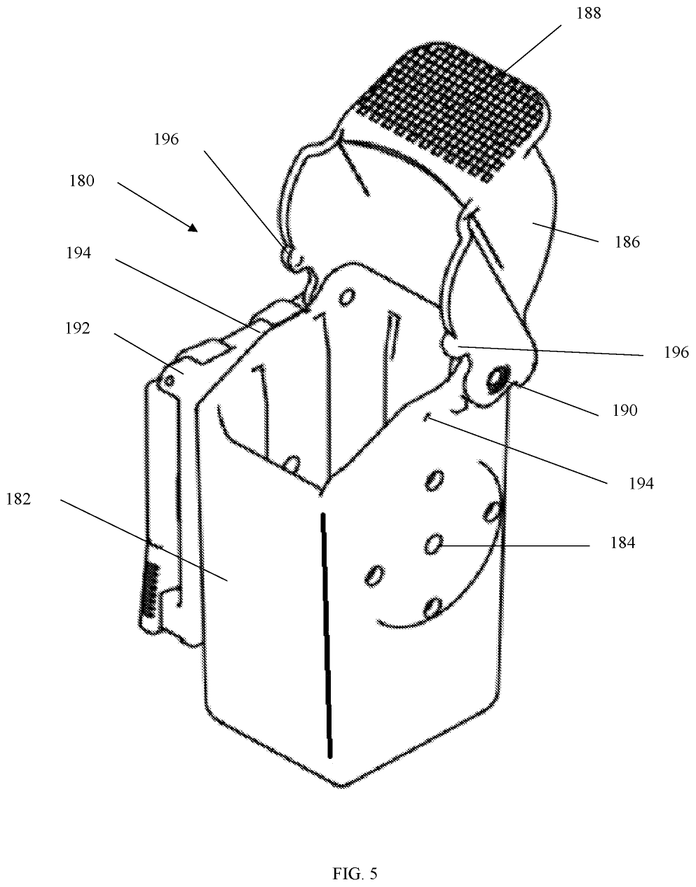

FIG. 5 is an isometric view of one embodiment of a holster in an open position that is part of the present invention. This view prominently shows the back and right sides of the holster. In some embodiments, a holster 180 is designed to hold the housing structure of the present invention. The holster 180 may include a holding chamber 182 having an interior and exterior, and configured to receive the distal end of the top portion of the handheld, non-lethal deterrent spraying device into the interior; a hood 186 hingedly attached to the holding chamber 182, the hood 186 being pivotable between a closed position and an open position about the housing structure, and a means for securing the holster 192 that is coupled to the holding chamber 182 via a receiver 184. The holster 180 may be made of durable materials such as plastics, wood, metals, rubber, and combinations thereof. The holding chamber 182, in ideal embodiments should either be manufactured to form-fit the device it receives, or it should have expandable or contractable walls within the interior of the holding chamber 182 which may be adjusted in order to provide a snug fit to the device received by the holster 180.

Further, the holding chamber 182 may be configured to provide retention holding for the housing structure. Retention holding is desirable because it may prevent fumbling when retrieving the housing structure from the holster 180. Further, retention holding may prevent the housing structure from being undesirably retrieved from the holster 180 by someone other than the user.

In some embodiments, the hood 186 may be attached to the holding chamber 182 by a hinge 190 that may include a fastener. This fastener could be a rivet, screw, bolt, grooved fitting, rod, peg, or other suitable means for allowing a rotatable connection between the hood 186 and the holding chamber 182. The depicted embodiment shows a hood 186 that rotates from the top (closed position) to the front (open position) of the holding chamber 182.

In some embodiments, the holster 180 includes at least one locking mechanism to secure the hood 186 in the closed position. One example of the locking mechanism may include a protruding section 196 in the interior of the hood 186 that fits into an adapted receiving section 194 of the holding chamber 182. The locking mechanism in the depicted embodiment secures the hood 186 in the closed position and the upward force of the user's thumb on a textured section 188 of the hood 186 puts the hood 186 in the open position. In further embodiments, the hood 186 may include additional locking mechanisms that secures the hood 186 in the open position.

In some embodiments, the hood of the holster may be secured in the closed position by a rachet and release mechanism. The rachet may only allow for movement that progresses the hood to the closed position. The release, in the form of a lever, button, pressure section, or other suitable method, would cease the rachet's prevention of the hood's progression towards the open position.

In some embodiments, the holding chamber has an attached latching member that extends upwards and latches to a latch receiver on the hood, locking the hood into the closed position. The latching member adds further assurance that the handheld, non-lethal deterrent spraying device will not be undesirably removed from the holding chamber. In alternative embodiments, the latching member may be attached to the hood and the latch receiver is on the holding chamber. In either embodiment, the hood is not moveable to the open position before the latching member is disengaged. In some embodiments, the user may quick disengage the latching member with their thumb before moving the hood to the open position. The latching member may be placed on the side of the hood opposite the side of the hood that is near the user's body when the holster is worn. This placement allows for the least amount of obstruction and difficulty when trying to quickly disengage the latching member. Alternatively, the latching member may be placed on the side of the hood nearest the user's body. This placement may allow the user's thumb more naturally disengage the latching member and makes it more difficult for others to disengage the latching member before the member is between the holster and the user's body.

In some embodiments, the hood may pivot about the left or right sides of the holding chamber. In such embodiments, the hinge may be moved from the sides of the holding chamber to the front and/or back of the holding chamber to allow for the left or right directional movement of the hood.

In some embodiments, at least one section of the hood may be designed to be retracted (by a spring or similar system) onto the exterior or into the interior of the holding chamber. This retraction may be aided by manipulation from the user, or it may be automatic after the user initiates the retraction of the hood by a method such as pushing a button on the side of the holster. Pushing the button may cause a lock to disengage on one part of the hood, allowing a spring to retract the hood into a stored position within the interior of the holding chamber.

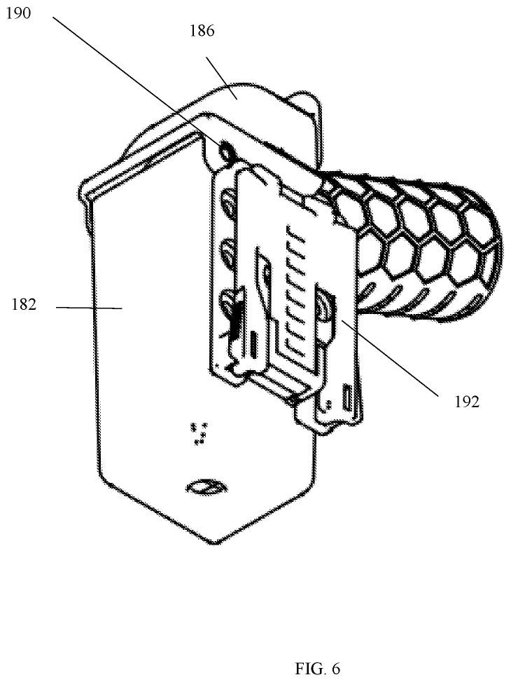

FIG. 6 is an isometric view of one embodiment of the holster of the present invention in the closed position. This view prominently shows the front and left sides of the holster. The depicted embodiment prominently features the hood 186 in the closed position while receiving one embodiment of the handheld, non-lethal deterrent spraying device and the means for securing the holster 192. Ideal embodiments include configuring the means for securing the holster 192 to the housing chamber in such a way that the means for securing the holster 192 does not interfere with the movement of the hood 186 between the open and closed positions. In some embodiments, this is accomplished by designing the means for securing the holster 192 in a way that it will not touch the hood 186 or hinge 190 and will not interfere with their movements.

In some embodiments, the hood may be secured to the right and left sides of the holding chamber by fasteners (screws, bolts, or rivets) that allow the hood to move between the open position and the closed position. Further, the fasteners (such as screws, bolts, or rivets) may be placed some measure down the right and left sides of the holding chamber (for example, about one-third down from the top of the holding chamber). In this design, the hood may need to be slanted as to allow the hood to be rotatable to the open position without the hood making contact with the holding chamber. This configuration of the hood is desirable because it allows the hood to provide restraint against the handheld, non-lethal deterrent spraying device being undesirably retried from the holster by someone other than the user. Put another way, this configuration allows the hood to stop another person from directly drawing the handheld, non-lethal deterrent spraying device prior to the hood being moved from the closed position to the open position.

In some embodiments, the hood may include a lip that allows the user to easily manipulate the hood between the open position and closed position. Further, the hood may include at least one textured section to provide the user's thumb or fingers with a better grip on the hood as the user moves the hood.

In some embodiments, some portion (such as all or part of the top portion) of the housing structure may be configured to have grooves, rails, indentations, or be generally shaped to match complimentary receiving topography of the holding chamber of the holster. This configuration of the housing structure and holding chamber allows the device to be more secure within the holster and prevent undesired removal of the device from the holster.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, which is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A handheld, non-lethal deterrent spraying device comprising:
a housing structure configured to have a grip portion and a top portion, the grip portion and top portion being aligned to give the housing structure a pistol-grip orientation, the grip portion and top portion having interiors and exteriors, and the top portion having a distal end opposite the end of the top portion coupled to the grip portion;
a reservoir within the grip portion of the housing structure for containing a non-lethal deterrent;
a nozzle recessed in a notch on the distal end of the top portion of the housing structure;
a channel that connects the reservoir to the nozzle;
an actuator that is accessible by a user and is manipulated by the user to engage a depressing member that causes the reservoir to discharge the reservoir's contents through the channel and out the nozzle; and
a cover member over the actuator, said cover member being attached to the housing structure, and being pivotable between a locked position which covers the actuator and an active position which allows the user to engage the actuator.

2. The handheld, non-lethal deterrent spraying device of claim 1 wherein the reservoir contains an aerosolized oleoresin capsicum spray.

3. The handheld, non-lethal deterrent spraying device of claim 1 wherein the exterior of the grip portion provides a grip configured to provide a user with a firm, non-slipping grasp on the device.

4. The handheld, non-lethal deterrent spraying device of claim 1 wherein the grip portion and the top portion of the housing structure are a single piece.

5. The handheld, non-lethal deterrent spraying device of claim 1 wherein the grip portion and the top portion of the housing structure are two coupled pieces.

6. The handheld, non-lethal deterrent spraying device of claim 1 wherein the top portion of the housing structure provides housing for at least one emitting member which has a power supply, a means for activation, a set of circuitry, and an emitter that emits through the distal end of the top portion of the housing structure.

7. The handheld, non-lethal deterrent spraying device of claim 6 wherein the at least one emitting member is selected from the group of light emitting diodes, laser diodes, incandescent bulbs, fluorescent bulbs, compact florescent bulbs, pressurized bulbs, high-intensity discharge bulbs, and combinations thereof.

8. The handheld, non-lethal deterrent spraying device of claim 1 wherein the power supply comprises a battery and a means for charging the battery.

9. The handheld, non-lethal deterrent spraying device of claim 1 wherein moving the cover over the actuator to the active position causes the means for activation of the at least one emitting device to activate and moving the cover member over the actuator to the locked position causes the means for activation of the at least one emitting device to deactivate.

10. The handheld, non-lethal deterrent spraying device of claim 1 wherein the actuator is a bidirectional switch configured to activate at least one emitting member when the user manipulates the bidirectional switch in an upward movement and configured to discharge the contents of the reservoir when the user manipulates the bidirectional switch in a downward movement.

11. The handheld, non-lethal deterrent spraying device of claim 1 wherein the reservoir is replaceable.

12. The handheld, non-lethal deterrent spraying device of claim 1 wherein a unit of swappable pieces including the reservoir, depressing member, channel, and nozzle is replaceable.

13. The handheld, non-lethal deterrent spraying device of claim 1 further comprising a holster having:
a holding chamber having an interior and an exterior, and configured to receive the distal end of the top portion of the handheld, non-lethal deterrent spraying device into the interior;
a hood hingedly attached to the holding chamber, the hood having an interior and exterior, and being pivotable between a closed position and an open position about the handheld, non-lethal deterrent spraying device;
and a means for securing the holster being attached to the holding chamber.

14. The handheld, non-lethal deterrent spraying device of claim 13 wherein the hood is hingedly attached to the holster by fasteners that are placed about one-third to half-way down from the top of the holding chamber, providing resistance to the handheld, non-lethal deterrent spraying device from being undesirably retrieved from the holster.

15. The handheld, non-lethal deterrent spraying device of claim 13 wherein the interior of the holding chamber is configured to provide passive holster retention for the handheld, non-lethal deterrent spraying device.

15. The handheld, non-lethal deterrent spraying device of claim 13 wherein the means for securing the holster is comprised of a securing clip configured to engage with a belt or strap and is attachable to at least one side of the holding chamber.

16. The handheld, non-lethal deterrent spraying device of claim 13 further comprising a friction pad coupled to the hood and designed to be engaged by the user's thumb.

17. The handheld, non-lethal deterrent spraying device of claim 13 further comprising a latching member attached to the housing chamber and said latching member extending upwards and latching to a latch receiver on the hood, locking the hood into the closed position.

18. A unit of swappable pieces for a handheld, non-lethal deterrent spraying device comprising:
a reservoir designed to reside within a grip portion of a housing structure of the handheld, non-lethal deterrent spraying device, the reservoir containing a non-lethal deterrent;
a nozzle recessed in a notch on the distal end of a top portion of the housing structure;
a channel that connects the reservoir to the nozzle; and
a depressing member that causes the reservoir to discharge the reservoir's contents through the channel and out the nozzle when the depressing member is engaged by an actuator on the handheld, non-lethal deterrent spraying device that is manipulated by a user.

19. The unit of swappable pieces for a handheld, non-lethal deterrent spraying device of claim 18 wherein the reservoir contains an aerosolized oleoresin capsicum spray.
